(19) United States
(12) Patent Application Publication
(10) Pub. No.: US 2025/0161729 A1
(43) Pub. Date: May 22, 2025

(54) ELECTRICAL FIRE PREVENTION AND PREDICTION SYSTEM FOR ELECTRICAL LOAD CIRCUITS BASED ON IoT

(71) Applicant: GNSM Co., Ltd., Ansan-si (KR)

(72) Inventors: SangMin Seo, Ansan-si (KR); GyeongHo Bae, Ansan-si (KR)

(73) Assignee: GNSM Co., Ltd., Ansan-si (KR)

(21) Appl. No.: 18/650,195

(22) Filed: Apr. 30, 2024

(30) Foreign Application Priority Data
Nov. 16, 2023 (KR) 10-2023-0158994
Mar. 18, 2024 (KR) 10-2024-0037282

(51) Int. Cl. A62C 3/16

(52) U.S. Cl. CPC A62C 3/16

(57) ABSTRACT

Disclosed is an electrical fire prevention and prediction system for electrical load circuits based on IoT, which may provide a user with driving information and error information of a freeze protection device, a cooler, and electrical load circuits in an electrical switchboard on a web. The electrical fire prevention and prediction system for electrical load circuits includes: an electrical load circuit; a controller controlling driving of the electrical load circuit, generating driving information of the electrical load circuit, and generating error information of the electrical load circuit based on the driving information; a communication device receiving the driving information and the error information from the controller; a monitoring server receiving the driving information and the error information from the communication device; and a user terminal accessing the monitoring server and receiving the driving information and the error information.

### CROSS-REFERENCE TO RELATED APPLICATIONS

This application claims the priority of Korean Patent Application Nos. 10-2023-0158994 and 10-2024-0037282 filed on Nov. 16, 2023, and Mar. 18, 2024, in the Korean Intellectual Property Office, the disclosure of which is incorporated herein by reference.

### BACKGROUND

### Field

The present disclosure relates to an electrical fire prevention and prediction system for electrical load circuits based on IoT, and more particularly, to an electrical fire prevention and prediction system for electrical load circuits based on IoT, which receives driving information and error information of an electrical device including an electrical load circuit from a control device through a wireless communication network, and provides a user with the received driving information and error information to be capable of preventing and predicting an electrical fire of the electrical load circuit.

### Description of the Related Art

Multiple electrical devices include electrical load circuits. The electrical device includes a freeze prevention device, a cooler, an electrical switchboard, and the like.

The freeze prevention device is for solving a problem in that when a temperature around a pipe is lowered below zero in the winter, a fluid in the pipe is frozen and expanded, and as a result, the pipe is frozen to burst, and as a representative freeze prevention device, there is a heating device (hereinafter, referred to as a ‘heater’) locally installed on the pipe and transmitting heat to the pipe. The heater is installed on one side of the pipe and maintains the temperature of the fluid in the pipe at a temperature of a freezing point or more.

However, when the heater is in operation for a long time, the heater is likely to cause a fire due to overheating, etc. In addition, as a connection between the heater and a control device (hereinafter referred to as a ‘controller’) that controls the heater is poor, a disconnection, an overcurrent, and a spark generation may occur, and there is a possibility that the fire will occur in the heater and the controller by disconnection, overcurrent, and spark generation.

Therefore, a necessity for a fire generation monitoring system that can monitor driving information of the heater, such as power and current supply states of the heater, and error information such as disconnection, overcurrent, and spark generation in real time emerges.

This is applied even to the cooler and the electrical switchboard, and when the cooler and the electrical switchboard are in operation for a long time, a fire can occur due to overheat, etc., and in addition, there is a possibility that the fire will occur in respective components and controllers due to disconnection, overcurrent, spark generation, etc., which occur as connections between respective components in the cooler and the electrical switchboard, and a controller controlling the respective components are poor.

A necessity for an electrical fire prevention and prediction system for electrical load circuits, which can monitor driving information such as power and current supply states of electrical load circuits in the electrical devices such as the freeze prevention device, the cooler, and the electrical switchboard, and error information such as disconnection, overcurrent, spark generation, etc. in real time emerges.

### SUMMARY

An object to be achieved by the present disclosure is to provide an electrical fire prevention and prediction system for electrical load circuits based on IoT, which may provide a user with driving information and error information of electrical load circuits in a freeze protection device, a cooler, and an electrical switchboard on a web.

Another object to be achieved by the present disclosure is to provide an electrical fire prevention and prediction system for electrical load circuits based on IoT, which includes a monitoring platform which a user accesses through a user terminal to confirm driving information and error information of the electrical load circuits in the freeze protection device, the cooler, and the electrical switchboard, and each component.

Yet another object to be achieved by the present disclosure is to provide an electrical fire prevention and prediction system for electrical load circuits based on IoT, which may be connected through a wireless communication network between a controller and a monitoring server.

In order to achieve the objects, an electrical fire prevention and prediction system for electrical load circuits based on IoT according to an exemplary embodiment of the present disclosure includes: an electrical load circuit; a controller controlling driving of the electrical load circuit, generating driving information of the electrical load circuit, and generating error information of the electrical load circuit based on the driving information; a communication device receiving the driving information and the error information from the controller; a monitoring server receiving the driving information and the error information from the communication device; and a user terminal accessing the monitoring server and receiving the driving information and the error information.

The driving information includes electrical power source information of the electrical load circuit, and the error information includes at least any one of disconnection, overcurrent, spark, current leakage, and overheat generation information of the electrical load circuit.

The controller generates fire occurrence possibility information based on at least any one of the disconnection, the overcurrent, the spark, the current leakage, and the overheat generation information of the electrical load circuit, and the monitoring server receives the fire occurrence possibility information through the communication device, and provides the fire occurrence possibility information to the user terminal.

The monitoring server includes a web server providing a monitoring platform to the user terminal.

The monitoring server receives the fire occurrence possibility information through the communication device, and then discloses a fire warning message and fire warning details information to the platform, and transmits, to the user terminal, a text message including the fire warning details information.

The electrical load circuit is included in each of a freeze prevention device, a cooler, and an electrical switchboard.

The controller further includes a heat dissipation detection module sensing heat dissipation of a cable.

The controller further includes a control module that restricts or interrupts supply current supplied to the cable according to a temperature of the cable sensed by the heat dissipation detection module.

In order to achieve the objects, an electrical fire prevention and prediction system for electrical load circuits based on IoT according to an exemplary embodiment of the present disclosure includes: a plurality of electrical devices; a plurality of controllers controlling driving of an electrical load circuit in the electrical device, generating driving information of the electrical load circuit, and generating error information of the electrical load circuit based on the driving information; a communication device receiving the driving information and the error information from the plurality of controllers; a monitoring server receiving the driving information and the error information from the communication device; and a user terminal accessing the monitoring server and receiving the driving information and the error information, and the monitoring server provides, to the user terminal, a plurality of driving information and error information received from the plurality of controllers, respectively.

The plurality of controllers includes identification numbers, respectively, and the monitoring server provides, to the user terminal, the plurality of driving information and error information jointly with the identification numbers.

The electrical fire prevention and prediction system further includes a plurality of communication devices, and the plurality of communication devices are connected to a plurality of controllers, respectively and grouped, and the monitoring server provides, to the user terminal, the plurality of driving information and error information jointly with group information in which a plurality of controllers connected to one communication device is grouped.

The monitoring system further includes a gateway device connecting the plurality of communication devices and the monitoring server, and the plurality of communication devices and the gateway device wirelessly communicate through a LoRa network.

The communication device and the monitoring server are connected through a wired communication network.

The electrical device is a freeze prevention device, a cooler, or an electrical switchboard.

According to an electrical fire prevention and prediction system for electrical load circuits based on IoT, which is the present disclosure, it is possible to provide a user with driving information and error information of electrical load circuits in a freeze protection device, a cooler, and an electrical switchboard, and each component on a web.

According to the electrical fire prevention and prediction system for electrical load circuits based on IoT, which is the present disclosure, it is possible to provide a monitoring platform which a user accesses through a user terminal to confirm driving information and error information of the electrical load circuits in the freeze protection device, the cooler, and the electrical switchboard, and each component.

According to the electrical fire prevention and prediction system for electrical load circuits based on IoT, which is the present disclosure, a connectivity between a controller and a monitoring server connected through a wireless communication network between the controller and monitoring server and installed at locations spaced apart from each other can be enhanced.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram schematically illustrating a configuration of an electrical fire prevention and prediction system for electrical load circuits based on IoT according to the present disclosure;

FIGS. 2 to 6 are flowcharts illustrating flows in which a controller generates error information, respectively;

FIGS. 7 to 10 are diagrams illustrating a state in which a web server provides a user terminal with driving information, a fire occurrence possibility, and error information of a heater;

FIG. 11 is a diagram illustrates a state in which the web server organizes driving information stored in a database server in time series, and provides the user terminal with the organized driving information;

Each of FIGS. 12 to 14 is a diagram illustrating a connection state of the user terminal which is connected to a monitoring platform;

FIG. 15 is a block diagram schematically illustrating another exemplary embodiment of the electrical fire prevention and prediction system for electrical load circuits based on IoT according to the present disclosure;

FIGS. 16 to 17 are diagrams illustrating a state in which a web server provides a user terminal with driving information, fire occurrence possibilities, and error information of a plurality of heaters;

FIG. 18 is a block diagram illustrating a configuration of a controller;

FIGS. 19 to 23 are flowcharts illustrating a flow in which a fourth monitoring unit detects the driving information of the heater, respectively;

FIG. 24 is a block diagram illustrating a configuration of the controller according to an exemplary embodiment;

FIG. 25 is a block diagram schematically illustrating a configuration of an electrical fire prevention and prediction system for electrical load circuits based on IoT according to another exemplary embodiment of the present disclosure; and

FIG. 26 is a block diagram schematically illustrating a configuration of an electrical fire prevention and prediction system for electrical load circuits based on IoT according to yet another exemplary embodiment of the present disclosure.

### DETAILED DESCRIPTION OF THE EMBODIMENT

Hereinafter, some exemplary embodiments of the present disclosure will be described in detail through exemplary drawings. When reference numerals refer to components of each drawing, it is to be noted that although the same components are illustrated in different drawings, the same components are denoted by the same reference numerals as possible.

Further, in describing the exemplary embodiments of the present disclosure, a detailed explanation of known related configurations and functions may be omitted to avoid interruption of understanding of the exemplary embodiments of the present disclosure.

In describing the components of the exemplary embodiments of the present disclosure, terms including first, second, A, B, (a), (b), and the like may be used. These terms are just intended to distinguish the components from other components, and the terms do not limit the nature, sequence, or order of the components.

In this specification, singular forms include even plural forms unless the context clearly indicates otherwise. It is to be understood that the terms “comprise” and/or “comprising” used in the specification do not exclude the presence or addition of one or more other components other than stated components.

Electrical devices 100, 110, and 120 according to the present disclosure include a freeze prevention device 100, a cooler 110, and an electrical switchboard 120. However, the electrical devices 100, 110, and 120 according to the present disclosure, which are not limited thereto, may include all electrical devices including electrical load circuits.

The electrical load circuits 11, 112, and 122 according to the present disclosure mean all electrical load circuits 11, 112, and 122 included in the above-described electrical devices 100, 110, and 120. The electrical load circuits 11, 112, and 122 according to the present disclosure may include electrical load circuits 11, 112, and 122 installed in the freeze prevention device 100, the cooler 110, and the electrical switchboard 120.

The electrical load circuits 11, 112, and 122 according to the present disclosure include all electrical networks in which an electrical power source, wires, and switches are connected so that current may flow, and electrical loads may be generated by the electrical power source.

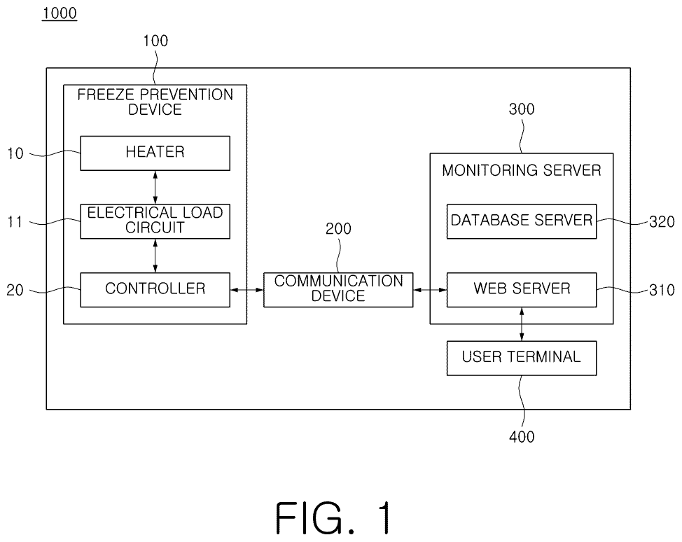

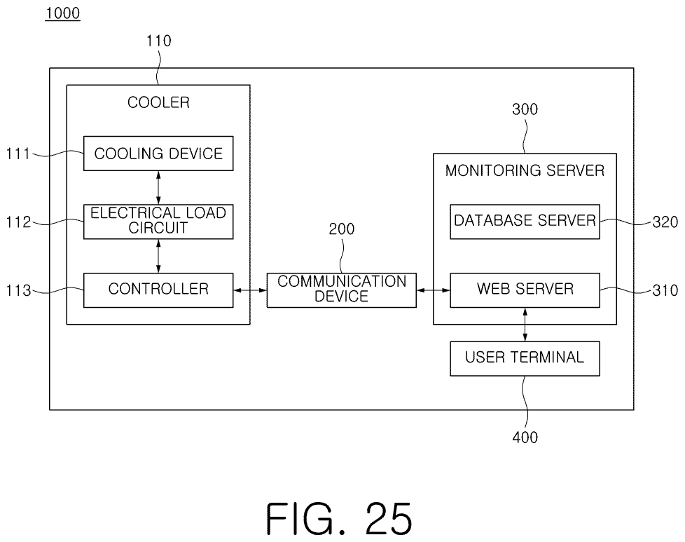

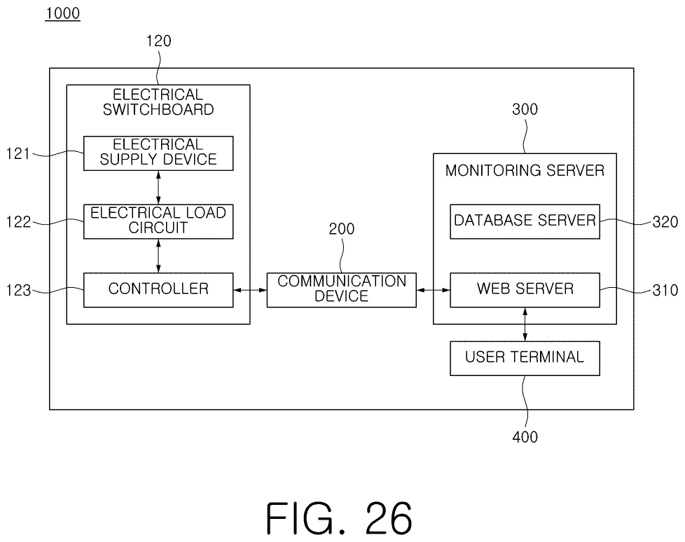

FIGS. 1 to 24 are diagrams describing each configuration of an electrical fire prevention and prediction system 1000 for electrical load circuits based on IoT according to the present disclosure, and driving and operation of each component based on the freeze prevention device 100. Respective components 10 and 20 described through FIGS. 1 to 24 may also be similarly applied to the cooler 110 and the electrical switchboard 120 described with reference to FIGS. 25 and 26.

Hereinafter, a case where the electrical devices 100, 110, and 120 including the electrical load circuits 11, 112, and 122 are the freeze prevention device 100 will be described as an example with reference to FIGS. 1 to 24. The respective components of the electrical fire prevention and prediction system 1000 for electrical load circuits based on IoT described with reference to FIGS. 1 to 24 may also be similarly applied to a case where the electrical devices 100, 110, and 120 are the cooler 110 or the electrical switchboard 120.

Hereinafter, the present disclosure is intended to be described in more detail with reference to the accompanying drawings.

FIG. 1 is a block diagram schematically illustrating a configuration of an electrical fire prevention and prediction system 1000 for electrical load circuits based on IoT according to the present disclosure. Specifically, FIG. 1 is a block diagram schematically illustrating a configuration of an electrical fire prevention and prediction system 1000 for electrical load circuits based on IoT when the electrical device is the freeze prevention device according to the present disclosure.

Referring to FIG. 1, the electrical fire prevention and prediction system 1000 for electrical load circuits based on IoT according to the present disclosure includes a freeze prevention device 100, a communication device 200, a monitoring server 300, and a user terminal 400.

The freeze prevention device 100 includes a heater 10 installed on a pipe and a controller 20 controlling driving of the heater 10. The freeze prevention device 100 includes an electrical load circuit 11 that connects an electrical power source, wires, switches, and the like so that current may flow between the heater 10 and the controller 20. The electrical load circuit 11 for driving the heater 10 is also included in the heater 10. The freeze prevention device 100 includes electrical load circuits 11 inside and outside the heater 10.

The heater 10 is installed on a pipe (not illustrated), and maintains a temperature of a fluid in the pipe constantly. The heater 10 may maintain the temperature of the fluid in the pipe at a temperature of a freezing point or more. Hereinafter, the heater 10 may also be referred to as a load. The heater 10 will be described later in detail.

The controller 20 controls driving of the heater 10 and the electrical load circuits 11 inside and outside the heater 10. The controller 20 detects the driving of the heater 10 and the electrical load circuits 11 inside and outside the heater 10 to generate driving information (hereinafter, referred to as ‘driving information of the heater 10’) of the heater 10 and the electrical load circuits 11 inside and outside the heater 10. The controller 20 generates error information of the heater 10 and the electrical load circuits 11 inside and outside the heater 10 based on the generated driving information.

The controller 20 may be connected to a plurality of heaters 10 in series or in parallel through the electrical load circuits 11, as an exemplary embodiment. As an exemplary embodiment, the controller 20 may receive error signals such as disconnection, overcurrent, spark generation, current leakage, and overheat of the heater 10 and/or the electrical load circuits 11 inside and outside the heater 10 from any one heater 10 among the plurality of heaters 10. As an exemplary embodiment, the controller 20 may generate error information such as disconnection, overcurrent, and spark generation of the heater 10 and/or the electrical load circuits 11 inside and outside the heater 10 based on driving information of the heater 10 detected from each of the plurality of heaters 10.

The controller 20 may be a control panel installed in the vicinity of a point where the heater 10 is installed. The controller 20 has an electrical fire response function. The driving information of the heater 10 includes electrical power source information of the heater 10 and the electrical load circuits 11 inside and outside the heater 10, current temperature information of the heater 10 and the electrical load circuits 11 inside and outside the heater 10, and setting temperature information of the heater 10 and the electrical load circuits 11 inside and outside the heater 10.

The electrical power source information of the heater 10 and the electrical load circuits 11 inside and outside the heater 10 includes consumed current and voltage information of the heater 10 and the electrical load circuits 11 inside and outside the heater 10.

The controller 20 may include a current meter (not illustrated) for detecting the consumed current of the heater 10 and the electrical load circuits 11 inside and outside the heater 10. As an exemplary embodiment, the controller 20 may include a clamp meter (not illustrated) detecting the consumed current of the heater 10 and the electrical load circuits 11 inside and outside the heater 10. The current meter may detect leakage current leaked to the outside of the wire. As an exemplary embodiment, the current meter may detect current which flows on an insulator around the wire. However, the current meter, which is not limited thereto, may detect the leakage current through a known method.

The controller 20 may include a voltage meter (not illustrated) for detecting voltages of the heater 10 and the electrical load circuits 11 inside and outside the heater 10. The controller 20 may further include a spark operating unit (not illustrated) for calculating the spark generation information of the heater 10 and the electrical load circuits 11 inside and outside the heater 10. The controller 20 may further include a voltage converter (not illustrated) converting and outputting input voltage measured by the voltage meter into predetermined voltage or current, and an A/D converter (not illustrated) converting and outputting an analog value output by the voltage converter into a digital signal. The spark operating unit calculates the spark generation information based on the digital signal output by the A/D converter.

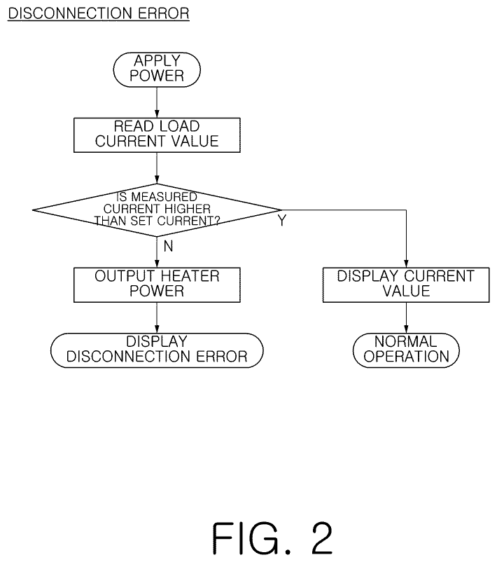

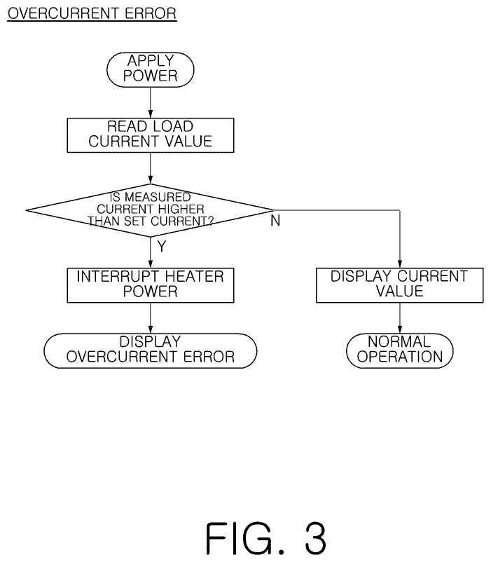

FIGS. 2 to 6 are flowcharts illustrating flows in which a controller 20 generates error information.

The controller 20 generates the error information based on the electrical power source information of the heater 10 and the electrical load circuits 11 inside and outside the heater 10. The controller 20 generates information regarding disconnection, overcurrent, spark generation, current leakage generation, overheat generation, and whether an error occurs in a temperature sensor in the heater 10 and the electrical load circuits 11 inside and outside the heater 10 based on the electrical power source information of the heater 10 and the electrical load circuits 11 inside and outside the heater 10.

Referring to FIG. 2, the controller 20 detects current (load current, consumed current of the heater and the electrical load circuits 11, etc.) which flows on the heater 10 and the electrical load circuits 11 inside and outside the heater 10, and generates disconnection information when the detected current is equal to or less than set current. As an exemplary embodiment, the controller 20 generates the disconnection information when the consumed current of the heater 10 is 20 mA or less.

Referring to FIG. 3, the controller 20 generates overcurrent error information when load current values of the heater 10 and the electrical load circuits 11 inside and outside the heater 10 are detected as the set current or more. As an exemplary embodiment, the controller 20 generates the overcurrent error information when the load current value is detected as AC 20 A or more.

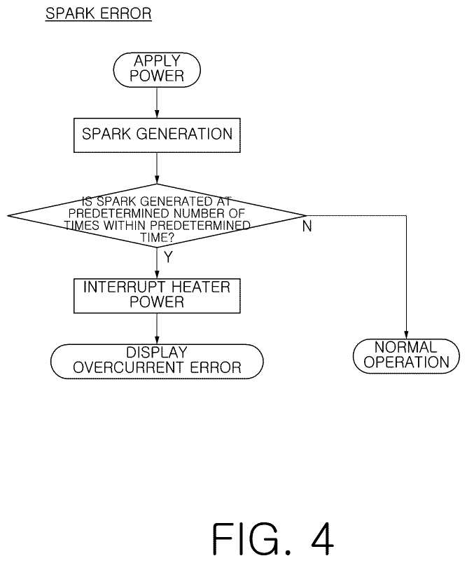

Referring to FIG. 4, the controller 20 generates spark error information when a spark is generated at a set number of times or more within a set time in the heater 10 and the electrical load circuits 11 inside and outside the heater 10. As an exemplary embodiment, the controller 20 generates the spark error information when the spark is generated three times or more within 5 minutes.

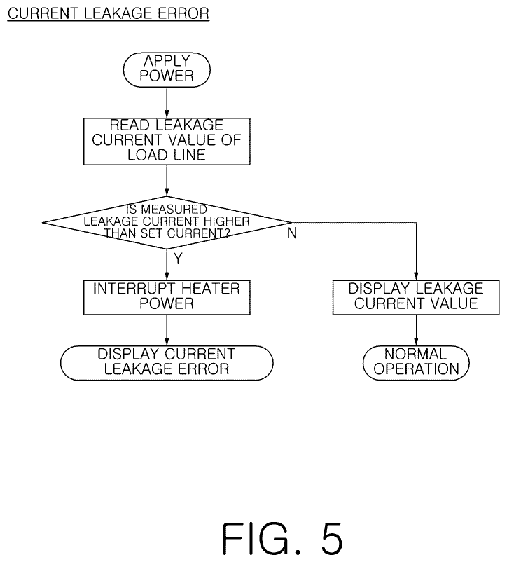

Referring to FIG. 5, the controller 20 detects leakage current in the heater 10 and the electrical load circuits 11 inside and outside the heater 10, that is, a load line, and generates current leakage error information when the detected leakage current is set current or more. As an exemplary embodiment, the controller 20 generates the leakage current error information when the detected leakage current is 200 mA or more.

The controller 20 detects overheat of the heater 10 and the electrical load circuits 11 inside and outside the heater 10 through a heat dissipation detection module 29 to be described below, and generates overheat error information when the detected overheat information is equal to or more than set overheat information.

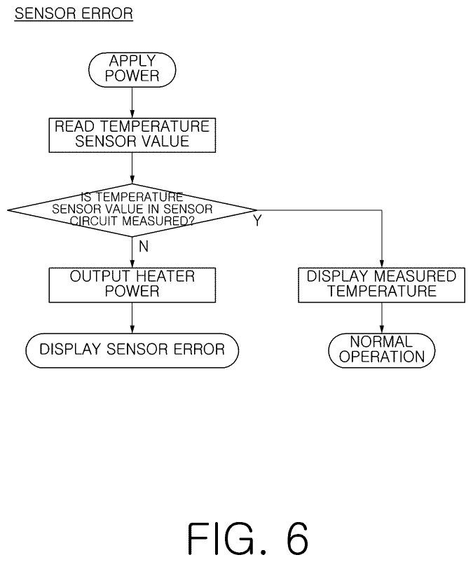

Referring to FIG. 6, the controller 20 generates temperature sensor error information when temperature measurement is not made from temperature sensors installed in the heater 10 and the electrical load circuits 11 inside and outside the heater 10.

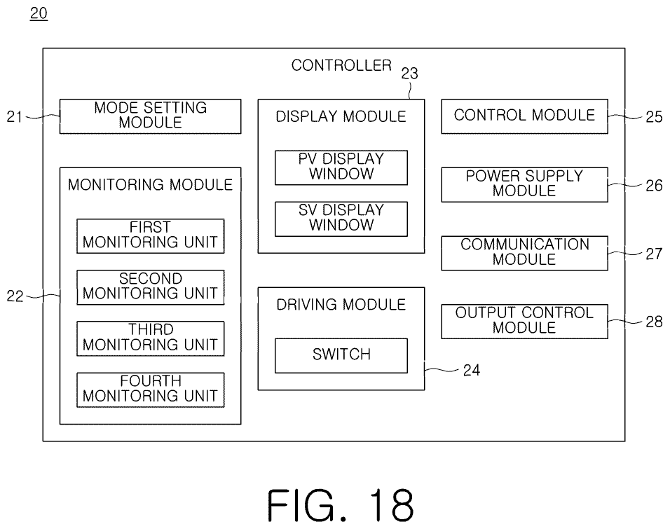

The controller 20 includes a display module 23 (see FIG. 18) displaying each of the driving information and error information of the heater 10 and the electrical load circuits 11. The display module 23 includes a process variable (PV) display window and a set point variable (SV) display window. The display module 23 may display a current temperature on the PV display window and display a setting temperature on the SV display window when displaying the driving information of the heater 10 and the electrical load circuits 11. The display module 23 may display a value of the consumed current of a current load (the heater 10 and the electrical load circuits 11 inside and outside the heater 10) jointly with the current temperature on the PV display window.

When the disconnection, the overcurrent, the spark, the current leakage, the overheat, and the error of the temperature sensor occur in the heater 10 and the electrical load circuits 11 inside and outside the heater 10, the display module 23 displays the information on each of the PV display window and the SV display window.

As an exemplary embodiment, the controller 20 generates fire occurrence possibility information based on disconnection, overcurrent, spark, current leakage, and overheat generation information of the heater 10 and the electrical load circuits 11 inside and outside the heater 10 closely connected to fire occurrence among a plurality of error information. The fire occurrence possibility information generated by the controller 20 as error information is displayed on the PV display window and the SV display window. That is, the error information includes the fire occurrence possibility information. The error information such as the disconnection, the overcurrent, and the spark generation may be the fire occurrence possibility information.

For example, the display module 23 displays ‘Erro’ on the PV display window and ‘-LC-’ on the SV display window when the disconnection error occurs between the heater 10 and the controller 20, and/or in the electrical load circuits 11 inside and outside the heater 10. The display module 23 displays ‘Erro’ on the PV display window and ‘-OC-’ on the SV display window when the overcurrent error occurs between the heater 10 and the controller 20, and/or in the electrical load circuits 11 inside and outside the heater 10. The display module 23 displays ‘Erro’ on the PV display window and ‘-Erro-’ on the SV display window when the spark error occurs between the heater 10 and the controller 20, and/or in the electrical load circuits 11 inside and outside the heater 10. The display module 23 displays ‘Erro’ on the PV display window and ‘≡EFC’ on the SV display window when the current leakage error occurs between the heater 10 and the controller 20, and/or in the electrical load circuits 11 inside and outside the heater 10. The display module 23 displays ‘SEnS’ on the PV display window and ‘-Erro’ on the SV display window when the error of the temperature sensor occurs between the heater 10 and the controller 20, and/or in the electrical load circuits 11 inside and outside the heater 10. The display module 23 displays an indication corresponding to overheat on each of the PV display window and the SV display window when the overheat error occurs between the heater 10 and the controller 20, and/or in the electrical load circuits 11 inside and outside the heater 10.

The communication device 200 receives driving information of the heater 10 and the electrical load circuits 11 inside and outside the heater 10, and error information generated based on the driving information from the controller 20. The communication device 200 may be installed at a point adjacent to the controller 20. The communication device 200 may be connected to the monitoring server 300 through a wired/wireless communication network. As an exemplary embodiment, the communication device 200 may be connected to the monitoring server 300 through a LoRa network.

LoRa as one of the low-power communication modulation technologies means a communication standard made for Internet of Things (IoT). LoRa has a feature in which communication of approximately a maximum of 10 miles (16 km) is enabled in a good environment with ultra-long distance connection and low power, and USIM is not required in communication by allocating a node number for each node. The LoRa network means a wireless communication network in which wireless communication using LoRa is enabled.

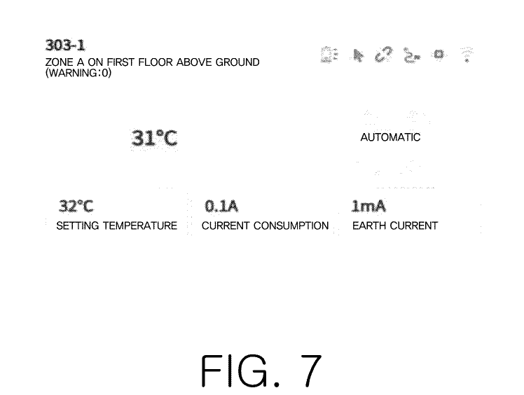

FIGS. 7 to 10 are diagrams illustrating a state in which a web server 310 provides driving information, fire occurrence possibility information, and error information of the heater 10 and the electrical load circuits 11 inside and outside the heater 10 to the user terminal 400.

The monitoring server 300 is connected to the communication device 200 through a wireless communication network. The monitoring server 300 receives, from the communication device 200, the driving information, the error information, and the fire occurrence possibility information. The monitoring server 300 receives, from the communication device 200, electrical power source information of the heater 10 and the electrical load circuits 11 inside and outside the heater 10, current temperature information of the heater 10 and the electrical load circuits 11 inside and outside the heater 10, setting temperature information of the heater 10 and the electrical load circuits 11 inside and outside the heater 10, and disconnection, overcurrent, spark, current leakage, overheat, and temperature sensor error information of the heater 10 and the electrical load circuits 11 inside and outside the heater 10.

The monitoring server 300 includes a web server 310 providing a monitoring platform to the user terminal 400. As illustrated in FIG. 7, the web server 310 provides, to the user terminal 400 which accesses the monitoring platform, driving information, fire occurrence possibility information, and error information of the heater 10 and the electrical load circuits 11 inside and outside the heater 10. The web server 310 provides, to the user terminal 400 accessing the monitoring platform, an identification number and a group number of the heater 10, installation location information of the heater 10, information on the number of warning times according to the fire occurrence possibility information, a current temperature, a setting temperature, current consumption, earth current, to be described below and a control mode of the heater 10 to be described below.

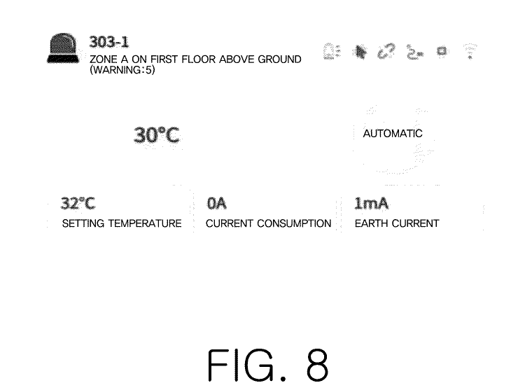

When the monitoring server 300 receives the fire occurrence possibility information through the communication device 200, the monitoring server 300 jointly displays a fire warning message on a display screen of the freeze prevention device 100 which becomes a basis of the fire occurrence possibility information on a platform. The fire warning message displayed by the monitoring server 300 may be a specific icon as illustrated in FIG. 8 as an exemplary embodiment.

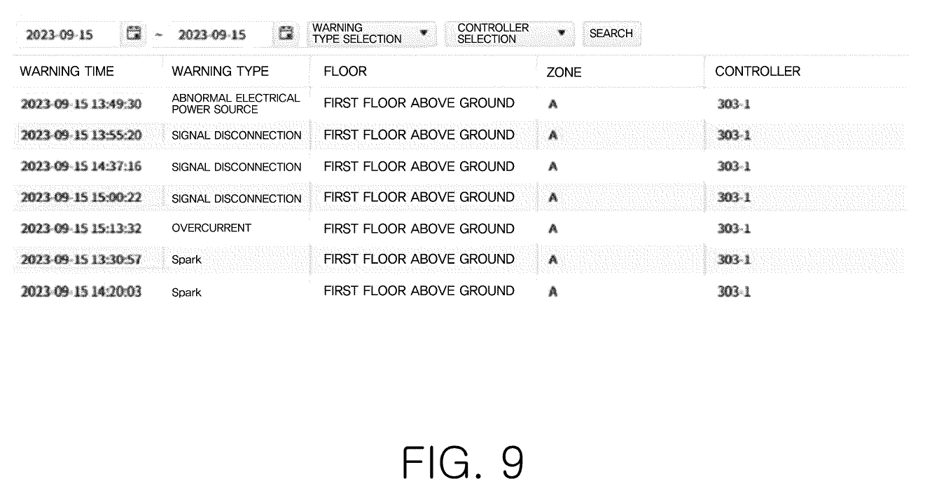

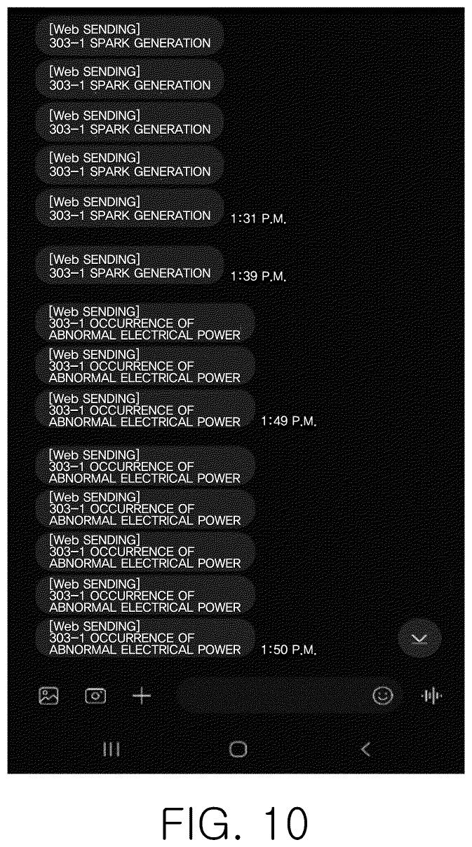

The monitoring server 300 may disclose information on fire warning details jointly with the fire warning message by referring to FIG. 9. As an exemplary embodiment, the user may access the platform through the user terminal 400, and then access a page in which the information on the fire warning details is disclosed as the user clicks on the display screen in which the fire warning message is displayed. The page in which the information on the fire warning details is disclosed includes a warning generation time, a warning type, information on a location where the freeze prevention device 100 is installed, location information of the controller 20, the identification number and the group number of the heater 10, etc.

When the monitoring server 300 discloses the fire warning message and the information on the fire warning details on the platform, the monitoring server 300 may transmit a text message including the information on the fire warning details to the user terminal 400 by referring to FIG. 10. The text message which the monitoring server 300 transmits to the user terminal 400 includes the identification information, the group number, warning type information, and the like of the heater 10 as an exemplary embodiment.

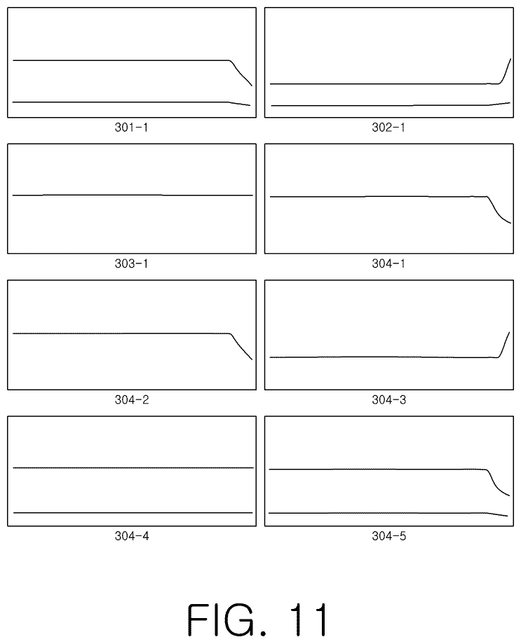

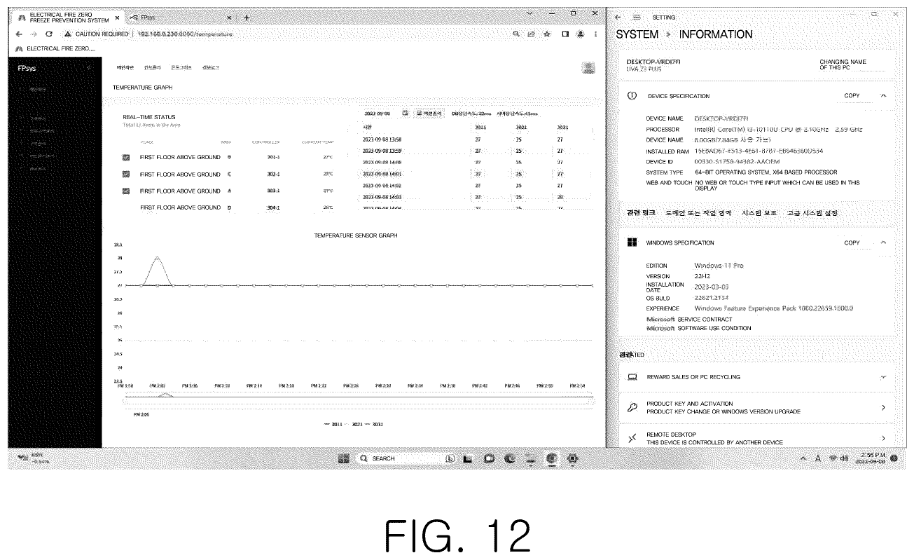

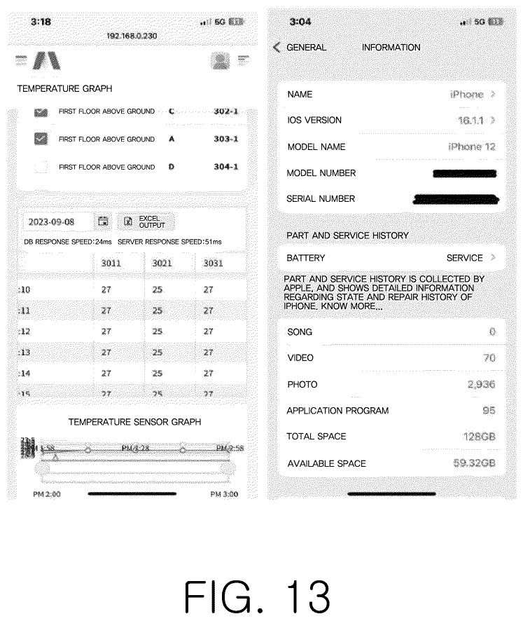

FIG. 11 is a diagram illustrating a state in which the web server 310 organizes driving information stored in a database server 320 in time series, and provides the user terminal 400 with the organized driving information.

The monitoring server 300 further includes the database server 320. The database server 320 stores the driving information, the fire occurrence possibility information, and the error information of the heater 10 and the electrical load circuits 11 inside and outside the heater 10. The web server 310 organizes the driving information, the fire occurrence possibility information, and the error information stored in the database server 320 in time series, and provides the organized time-series information to the user terminal 400 accessing the monitoring platform. For example, as illustrated in FIG. 11, the web server 310 organizes the current consumption information of the heater 10 and the temperature information of the heater 10 in time series, and provides the organized time-series information to the user terminal 400.

Each of FIGS. 12 to 14 is a diagram illustrating a connection state of the user terminal 400 which is connected to a monitoring platform.

The user terminal 400 accesses the monitoring server 300, specifically, the monitoring platform of the web server 310 to receive the driving information, the fire occurrence possibility information, and the error information. The user terminal 400 includes input means such as a keyboard, a mouse, a touch pad, a touch screen, etc., and terminals such as a desktop PC, a laptop PC, a tablet PC, a smartphone, etc., which have a display screen. For example, the user terminal 400 may be a PC, a smartphone, and/or a tablet PC having Windows, iOS, and/or Android as an OS. A connection state of the PC having Windows as the OS is illustrated in FIG. 12, a connection state of the smartphone having iOS as the OS is illustrated in FIG. 13, and a connection state of the smartphone having Android as the OS is illustrated in FIG. 14.

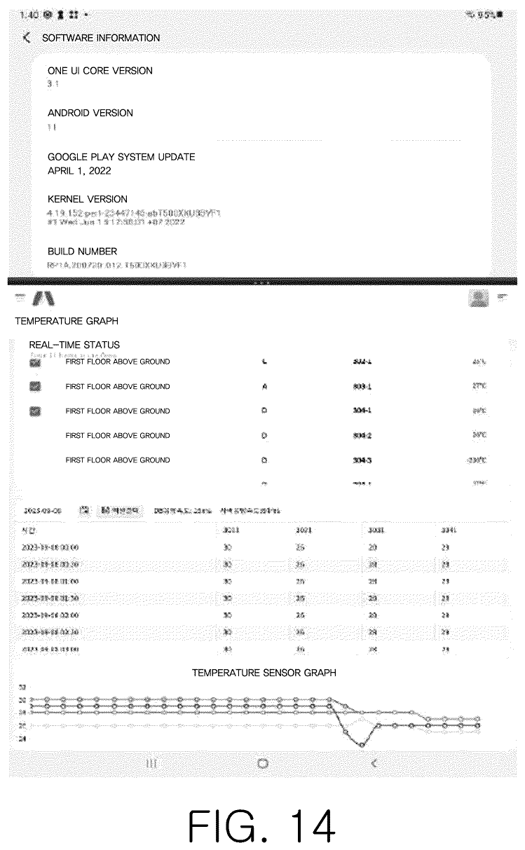

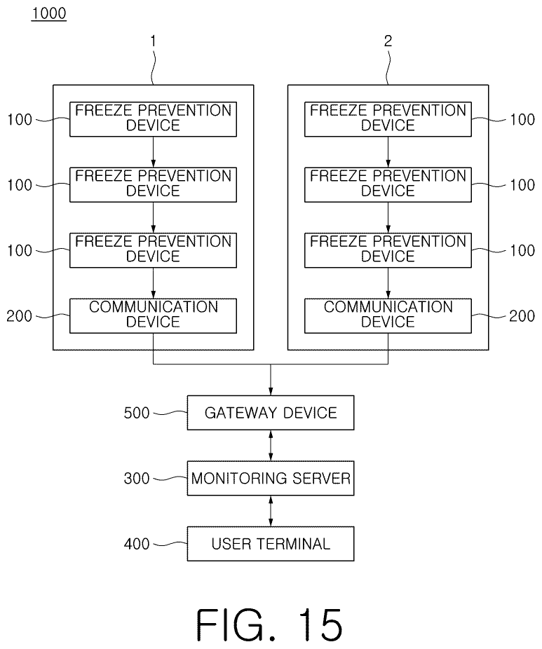

FIG. 15 is a block diagram schematically illustrating another exemplary embodiment of the electrical fire prevention and prediction system 1000 for electrical load circuits based on IoT according to the present disclosure.

Referring to FIG. 15, the electrical fire prevention and prediction system 1000 for electrical load circuits based on IoT according to the present disclosure may include a plurality of freeze prevention devices 100. Each freeze prevention device 100 includes at least one heater 10, an electrical load circuit 11, and a controller 20. The plurality of freeze prevention devices 100, specifically, a plurality of controllers 20 in the plurality of freeze prevention devices 100 may be connected to at least one communication device 200. The plurality of controller 20 may be connected to at least one communication device 200 in series or in parallel. At least one communication device 200 may receive driving information, fire occurrence possibility information, and error information of the heater 10 and the electrical load circuits 11 inside and outside the heater 10 from each of the plurality of controllers 20. At least one communication device 200 transmits, to the monitoring server 300, the driving information, fire occurrence possibility information, and error information received from each of the plurality of controllers 20.

The monitoring server 300 provides a plurality of driving information, fire occurrence possibility information, and error information received from the plurality of controllers 20, respectively to the user terminal 400.

Each of the plurality of heaters 10 includes an identification number. The monitoring server 300 displays the driving information, the fire occurrence possibility information, and the error information on the monitoring platform jointly with the identification number of each heater 10.

The electrical fire prevention and prediction system 1000 for electrical load circuits based on IoT according to the present disclosure may include a plurality of communication devices 200. The respective communication devices 200 are connected to the plurality of controllers 20, respectively. The respective communication devices 200 are connected to the plurality of controllers 20, respectively, and grouped. For example, one communication device 200 and the plurality of controllers 20 connected to the one communication device 200 may be grouped into a first group 1, and the other one communication device 200 and a plurality of controllers 20 connected to the other one communication device 200 may be grouped into a second group 2.

The plurality of communication devices 200 may be connected to the plurality of controllers 20, respectively in series or in parallel. The plurality of communication devices 200 transmits, to the monitoring server 300, the driving information, fire occurrence possibility information, and error information received from the freeze prevention device 100 in each group.

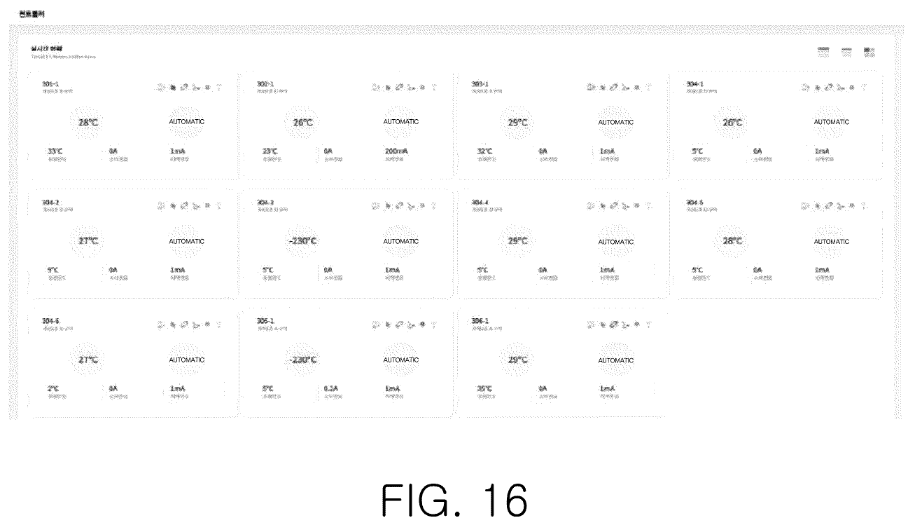

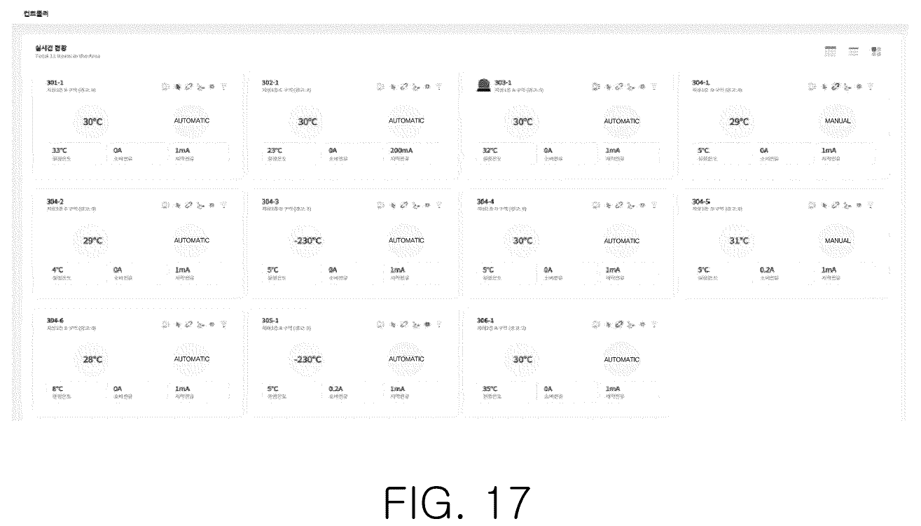

FIGS. 16 to 17 are diagrams illustrating a state in which a web server 310 provides driving information, fire occurrence possibility information, and error information of a plurality of heaters 10 and the electrical load circuits 11 inside and outside the heaters 10 to the user terminal 400.

Referring to FIGS. 16 and 17, the monitoring server 300 provides the driving information, fire occurrence possibility information, and error information received from the plurality of communications devices 200, respectively to the user terminal 400. When the monitoring server 300 provides the driving information, fire occurrence possibility information, and error information received from the plurality of communication devices 200, respectively to the user terminal 400, the monitoring server 300 provides, to the user terminal 400, group information in which a communication device 200 in the group and a plurality of controllers 20 connected to the communication device 200 are grouped, jointly. For example, when heaters 10 have serial numbers of 304-1, 304-2, 304-3, 304-4, and 304-5, respectively, front 304 may mean the group information, and rear 1 to 5 may mean the identification numbers of the heaters 10. Alternatively, front 304 may mean the group information, and all serial numbers including 1 to 5 may also mean the identification numbers.

Heaters 10 and electrical load circuits 11 of the same group may be each installed on the same pipe line. Accordingly, there is a feature that the user may easily know installation locations of a heater 10 and an electrical load circuit 11 in which a warning is generated according to the fire occurrence possibility information through the group number in the monitoring platform.

The electrical fire prevention and prediction system 1000 for electrical load circuits based on IoT may further include a gateway device 500 connecting the plurality of communication devices 200 and the monitoring server 300. The gateway device 500 may be connected to the communication device 200 through the wireless communication network. As an exemplary embodiment, the communication device 500 may be connected to the monitoring server 300 through the wired communication network. The gateway device 500 is possible to wireless communicate with the communication device 200 through the LoRa communication network according to the LoRa communication standard.

Hereinafter, the heater 10 and the controller 20 according to an exemplary embodiment of the present disclosure will be described.

The controller 20 is connected to a plurality of heaters 10 to control operations of respective heaters 10 according to driving states of the plurality of heaters 10. According to an exemplary embodiment, the controller 20 may be connected to the plurality of heaters 20 in parallel, and receive error signals such as disconnection, overcurrent, etc., of the heater 10 and the electrical load circuits 11 inside and outside the heater 10 from any one heater 10 among the plurality of heaters 10.

The hater 10 transmits heat to a pipe and heats a fluid accommodated inside the pipe to prevent the pipe from being frozen. When the heat is transmitted to the pipe, a fluid which flows on the pipe may cause a convention phenomenon, and the fluid may maintain a room temperature state in general.

That is, the heater 10 may locally transmit the heat to only a part of the pipe, and the fluid which flows along the pipe may heat an overall fluid by the convection phenomenon. As a result, a material consumption amount and an electricity consumption amount may be significantly reduced as compared with a heat wire installed in an entire section of the pipe and heating the pipe overall, and as a result, installation cost and maintenance cost of a facility for freezing prevention may be reduced.

Moreover, in an exemplary embodiment of the present disclosure, it is described that the heater 10 is used for preventing the pipe from being frozen, but the heater 10 is not limited thereto. The heater 10 of the present disclosure may be usable for heating other objects.

Meanwhile, the heater 10 may accommodate a heating unit for heating the pipe therein. Specifically, the heater 10 includes a housing (not illustrated) accommodating the heating unit therein. The housing maintains a contact state with the heating unit to transmit heat dissipated from the heating unit to the pipe.

To this end, the housing may be made of an aluminum material with high heat conductive efficiency and strong durability. Besides, the housing may also be made of a metal-based material having a high heat conductive efficiency, such as stainless steel.

The housing may have a hollow pipe shape in which the housing is enabled to be accommodated inside the heating unit in a longitudinal direction. Here, the heating unit may have a bar shape having a predetermined length, and may be accommodated in the housing and placed in a contact state with an inner surface of the housing.

The heating unit may receive AC power from the controller 20 through the electrical load circuits 11 inside and outside the heater 10. Moreover, signal lines connected to the controller 20 may be additionally placed in regions where the electrical load circuits 11 inside and outside the heater 10 are placed. The heater 10 may receive a line error signal or a control signal from the controller 20 through the corresponding signal line.

The housing does not have a gap that causes heat loss, but has an outer surface which is provided in a shape corresponding to an outer surface of the pipe to maximize heat transmission efficiency of the heating unit.

Further, the heater 10 may further include a plurality of covers (not illustrated) for covering openings at one side and the other side of the housing. The plurality of covers may be made of a heat-resistance material which is not deformed by heat.

As such, in the heater 10, the housing is made of the metal-based material and the plurality of covers covering an opened region of the housing is made of the heat-resistance material, so an exterior may be less deformed even though a shock is applied from the outside or the covers are used for a long time.

FIG. 18 is a block diagram illustrating a configuration of a controller 20.

Specifically, referring to FIG. 18, the controller 20 may include a mode setting module 21, a monitoring module 22, a display module 23, a driving module 24, a control module 25, a power supply module 26, a communication module 27, and an output control module 28. Respective components of the controller 20 may transmit and receive data to and from each other through one or more communication buses or signal lines.

The mode setting module 21 may set a control mode of the heater 10 dissipating heat to the pipe. Control mode information of the heater 10 may be transmitted to the monitoring server 300 and provided to the user terminal 400 on the monitoring platform. Specifically, the mode setting module 21 may be configured to set at least one of whether to automatically control the heater 10, a reference temperature of the heater 10 (e.g., a reference value for operating the heater 10, 1 to 80° C.), a temperature error correction value of the heater 10 (e.g., −9° C. to +9° C.), whether low current of the heater 10 is detected (e.g., in the case of “-off”, an output of the heater 10 is opened and low current is not detected, and in the case of “-on”, the output of the heater 10 is opened and low current of 150 mA (35 W) or less is detected), and a device identification number (e.g., #1 to 100).

The mode setting module 21 may set the control mode of the heater 10 through a physical button. For example, the mode setting module 21 may set the control mode through a button provided on the outer surface of the controller 20. As another example, the mode setting module 21 may receive a control mode setting input from the keyboard, the touch screen, the microphone, etc. Alternatively, the mode setting module 21 may also receive a mode setting input value from the user terminal 400 accessing the monitoring platform.

According to an exemplary embodiment, a first setting mode of automatically turning on/off the operation of the heater 10 and a second setting mode of manually turning on the operation of the heater 10 may be set through the mode setting module 21. For example, when the heater 10 is automatically controlled through the mode setting module 21, a temperature of the heater 10 may be automatically controlled according to a temperature value of the heater 10 measured by the monitoring module 22 to be described below. As another example, when the heater 10 is manually controlled through the mode setting module 21, the heater 10 may be controlled to continuously operate manually regardless of the temperature value of the heater 10 measured by the monitoring module 22.

Meanwhile, data set through the mode setting module 21 may be visually output through the display module 23. Specifically, the display module 23 may output different temperature control data according to the first and second setting modes. For example, in the case of the first setting mode, the display module 23 may output a previously set automatic control temperature (set point variable (SV)) value jointly with a current temperature (process variable (PV)), and in the case of the second setting mode, the display module 23 may output state data (e.g., “H-on”) indicating that the heater 10 is manually controlled jointly with the PV.

The display module 23 may output the control mode of the controller 20 through the mode setting module 21 or an operation state set by the monitoring module 22. Specifically, the display module 23 may include a first display unit that may visually output the PV, the SV, and the state data. The first display unit may include at least two of four flexible numeric displays (FNDs), and output numbers and characters through seven segments. The first display unit includes the PV display window and the SV display window described above.

Moreover, the display module 23 may include a second display unit for fragmentally informing the operation state of the controller 20 to the user. The second display unit may be constituted by a plurality of LEDs, and colors output by the LEDs may mean different operation states. For example, a green LED indicates a power input state display of the controller 20, which may inform that a power supply abnormal state of the control module 25 occurs. As another example, a red LED may inform that the heater 10 is operating, and a yellow LED may inform that various errors including disconnection, overcurrent, short-circuit, etc., occur in the heater 10, the electrical load circuit 11, and/or the controller 20. Moreover, the controller 20 may inform a transmission/reception state with the monitoring server 300 through the green/red LED of the second display unit.

The monitoring module 22 may monitor the operation states of the heater 10 and/or the electrical load circuit 11. Specifically, the monitoring module 22 may include a first monitoring unit configured to measure a temperature of a region where the heater 10 and/or the electrical load circuit 11 are/is placed, a second monitoring unit configured to measure a temperature of a region adjacent to the driving module 24, a third monitoring unit configured to detect current which flows on the heater 10 and/or the electrical load circuit 11, and a fourth monitoring unit configured to confirm various error signals related to a connection line of the heater 10 and/or the electrical load circuit 11.

Here, a monitoring unit configured to measure the temperature may include temperature sensors (an NTC sensor, a temp sensor), and a monitoring unit configured to measure a current amount may include a current sensor.

The fourth monitoring unit may detect a heater line error signal of the heater 10 and/or the electrical load circuit 11 from an output terminal connected to the heater 10. According to an exemplary embodiment, the fourth monitoring unit is connected to the first to third monitoring units, and heater line error signals of a plurality of heaters 10 and/or electrical load circuits 11 to detect a heater line error signal from any one heater 10 and/or electrical load circuit 11 among the plurality of heaters 10 and/or electrical load circuits 11. For example, the heater line error signal includes a disconnection error, an overcurrent error, a spark error, a current leakage error, and a sensor error as described above.

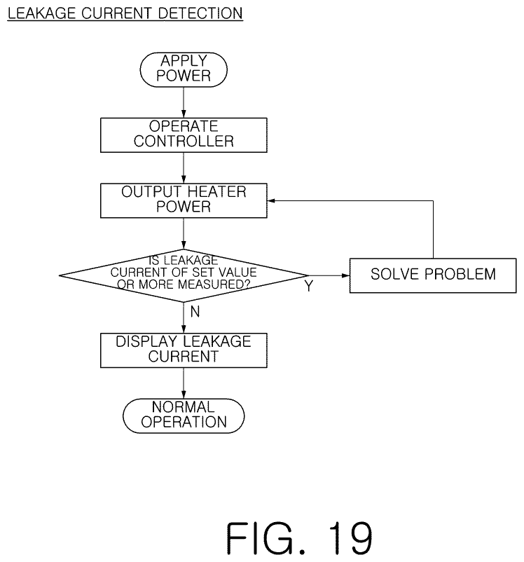

FIGS. 19 to 23 are flowcharts illustrating a flow in which a fourth monitoring unit detects the driving information of the heater 10, respectively.

The fourth monitoring unit enables leakage current detection of the heater 10 and/or the electrical load circuits 11 inside and outside the heater 10, difference detection between a setting temperature and a measured temperature, and current consumption detection in addition to the above-described error signals.

Referring to FIG. 19, the fourth monitoring unit may detect leakage current of the heater 10 and/or the electrical load circuits 11 inside and outside the heater 10. The fourth monitoring unit may detect leakage current of a set value or more when outputting the power of the heater 10. The control module 25 to be described below operates the heater 10 and/or the electrical load circuit 11 based on a leakage current detection value of the fourth monitoring unit. Specifically, the control module 25 normally operates the heater 10 and/or the electrical load circuit 11 only when the fourth monitoring unit does not detect leakage current of a set value, e.g., 200 mA or more. The control module displays the detected leakage current value on the display module 23 when the heater 10 and/or the electrical load circuit 11 normally operates.

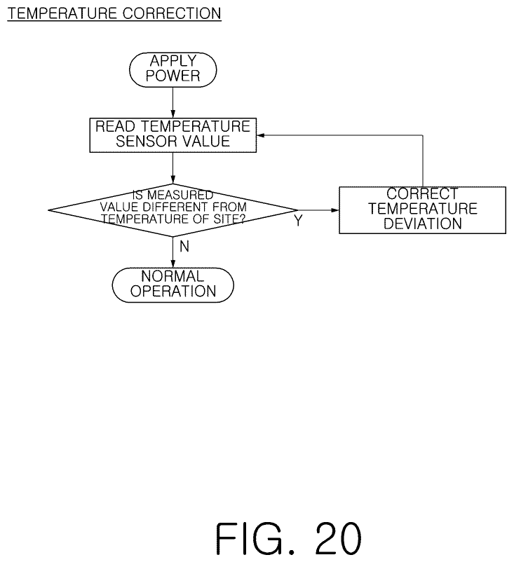

Referring to FIG. 20, the fourth monitoring unit compares a temperature value measured by temperature sensors of the heater 10 and/or the electrical load circuits 11 inside and outside the heater 10 and a temperature value measured by a separate temperature sensor that detects a temperature of an entire site where the heater 10 and/or the electrical load circuits 11 are installed to correct output values of the temperature sensors. To this end, the temperature sensor may include each of the temperature sensor measuring the temperature of the heater 10 and/or the electrical load circuits 11 and the temperature sensor detecting the temperature of the site where the heater 10 and/or the electrical load circuits 11 are/is installed. The fourth monitoring unit may correct the output values of the temperature sensors when there is a difference between the measured temperature sensor value and the temperature value of the site.

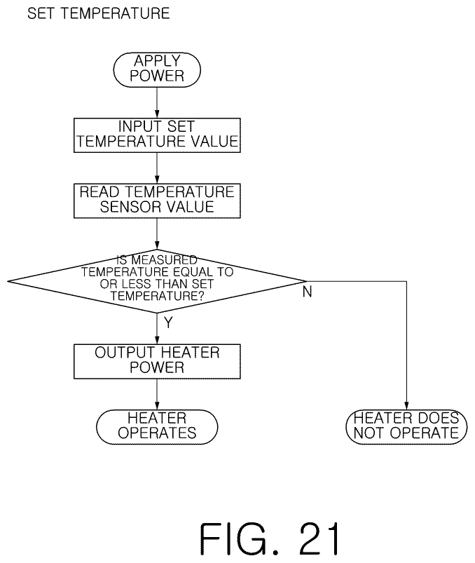

Referring to FIG. 21, the fourth monitoring unit compares current temperatures and setting temperature values of the heater 10 and/or the electrical load circuits 11 inside and outside the heater 10. The control module determines whether the heater 10 operates based on a comparison value of the fourth monitoring unit.

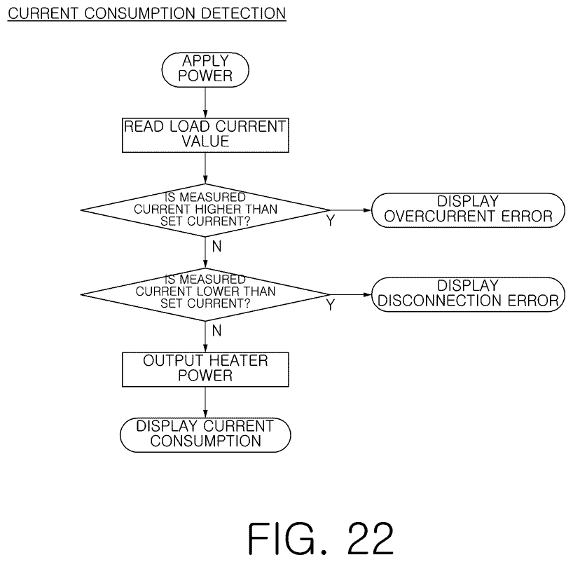

Referring to FIG. 22, the fourth monitoring unit detects a consumption current value of a load, i.e., the heater 10 and/or the electrical load circuits 11 inside and outside the heater 10, detects an overcurrent error when the detected consumption current value is higher than a set current value, and detects a disconnection error when the detected consumption current value is lower than the set current value. In the case of the overcurrent error, the set current value may be 20 A, and in the case of the disconnection error, the set current value may be 20 mA. The control module displays the detected consumption current value on the display module 23 when the heater 10 normally operates.

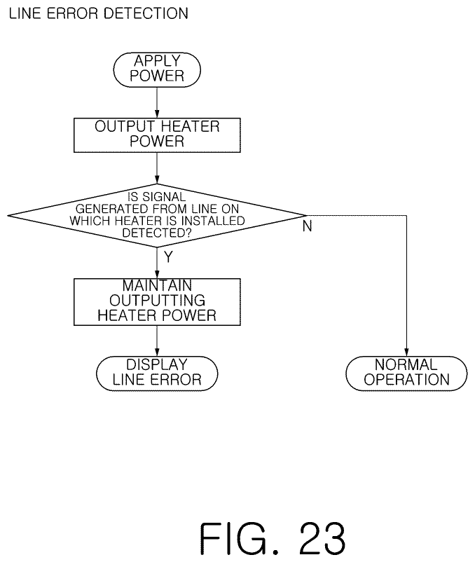

Referring to FIG. 23, the fourth monitoring unit may detect heater line errors of the heater 10 and/or the electrical load circuits 11 inside and outside the heater 10. The fourth monitoring unit may detect a signal generated from signal lines on which the heater 10 and/or the electrical load circuit 11 are/is installed when outputting the power of the heater 10 and/or the electrical load circuit 11. The control module displays the heater line error on the display module 23 in a state of maintaining the output of the power of the heater 10 when the fourth monitoring unit detects the signal on the signal line on which the heater 10 and/or the electrical load circuit 11 are/is installed.

The driving module 24 may control output voltage supplied to the heater 10 and/or the electrical load circuits 11 inside and outside the heater 10. To this end, the driving module 24 may include a switch, and for example, the switch may be a non-contact switch.

The control module 25 is connected to the mode setting module 21, the monitoring module 22, the display module 23, the driving module 24, the power supply module 26, the communication module 27, and the output control module 28 to control an overall operation of the controller 20. The control module 25 may monitor an operation of the heater 10 and/or the electrical load circuit 11 through a program stored in a memory (not illustrated), and accordingly, perform various instructions for controlling the operation of the heater 10 and/or the electrical load circuit 11.

The control module 25 may correspond to an operation device such as a microprocessor, a central processing unit (CPU), etc. Further, the control module 25 may be implemented in the form of an integrated chip (IC) such as a system on chip (SoC) in which various operation devices are integrated.

The control module 25 may switch on/off of the heater 10 and/or the electrical load circuit 11 according to a comparison result of the temperature value measured through the first monitoring unit and a predetermined first reference temperature. Here, the first reference temperature may vary depending on a specification of the heater 10 and/or the electrical load circuit 11 or a setting value of the user. For example, the control module 25 may switch the heater 10 and/or the electrical load circuit 11 to an on state when the measured current temperature is equal to the predetermined first reference temperature in a state in which the heater 10 and/or the electrical load circuit 11 are/is off, and maintain an off state of the heater 10 and/or the electrical load circuit 11 when the measured current temperature is higher than the predetermined first reference temperature. As another example, the control module 25 may switch the heater 10 and/or the electrical load circuit 11 to an off state when the measured current temperature is higher than the predetermined first reference temperature in a state in which the heater 10 and/or the electrical load circuit 11 are/is on, and maintain an on state of the heater 10 and/or the electrical load circuit 11 when the measured current temperature is equal to the predetermined first reference temperature.

According to an exemplary embodiment, the control module 25 may confirm the temperature value measured through the first monitoring unit, and the identification number of the heater 10 and/or the electrical load circuit 11 in a region (space) where the temperature value is measured. As a result, operation states of all heaters 10 and/or electrical load circuits 11 of which on/off state switching is required may be simultaneously controlled.

The control module 25 may confirm the disconnection of the heater 10 and the electrical load circuits 11 inside and outside the heater 10 through the fourth monitoring unit before transferring an operation control signal to the driving module 24. When the heater 10 or the electrical load circuits 11 inside and outside the heater 10 are disconnected according to a confirmation result, the control module 25 may stop output voltage supply connected to the heater 10 through the driving module 24.

Moreover, the control module 25 may output a short-circuit notification with the heater 10 and/or the electrical load circuit 11 through the display module 23, and for example, the display module 23 may output visual short-circuit notifications such as “Erro” and “-SH-”.

Meanwhile, the control module 25 may confirm a contact failure with the heater 10 and the electrical load circuits 11 inside and outside the heater 10 in addition to the short-circuit of the heater 10 and the electrical load circuits 11 inside and outside the heater 10 through the fourth monitoring unit. Specifically, the control module 25 may detect a current amount change to the heater 10 and the electrical load circuits 11 inside and outside the heater 10 through the fourth monitoring unit. When the current amount change is detected at a predetermined number of times or more for a predetermined time, the control module 25 may stop the output voltage supply to the heater 10 and the electrical load circuits 11 inside and outside the heater 10 through the driving module 24, and adjust the amount of output voltage output to the heater 10 and the electrical load circuits 11 inside and outside the heater 10 through a cycle control mode. Here, the cycle control mode is a mode of controlling the number of output cycles of AC power of 60 Hz and 200 V supplied to the heater 10 and/or the electrical load circuit 11, and for example, the control module 25 may sequentially increase or repeat the number of cycles of the AC power output to the heater 10 and/or the electrical load circuit 11. For example, the control module 25 may output AC power of a first cycle corresponding to one cycle, output AC power of a second cycle corresponding to three cycles, and output AC power of a third cycle corresponding to one cycle, and output AC power of a fourth cycle corresponding to three cycles again. Moreover, the control module 25 may stop outputting power for a predetermined time in order to pass to a next cycle. Here, the predetermined time may be a short time of 10 s or less.

As such, as the contact failure is detected, the control module 25 does not completely interrupt the output of the power to the heater 10, but continuously supplies the power to prevent damage to the heater 10.

Moreover, the control module 25 may output a contact failure notification of the heater 10 and/or the electrical load circuit 11 through the display module 23. For example, the display module 23 may output a visual contact failure notification such as “Erro” or “ARC”.

The control module 25 may determine whether the current detected through the third monitoring unit is equal to or less than a predetermined first current value in a state in which the mode setting module 21 is set to detect low current. When the detected current is equal to or less than the predetermined first current value, the control module 25 may display a low-current error code through the display module 23, and maintain the output voltage supply. Further, while the control module 25 detects the low current, the control module 25 may also detect non-current of the heater 10 and/or the electrical load circuits 11 inside and outside the heater 10. In this case, the control module 25 may display a non-current error code through the display module 23, and maintain the output voltage supply.

A first current value which becomes a reference for the control module 25 to display the low-current error code may be 125 mA to 175 mA. More specifically, the controller 20 may monitor whether the current flowing on the heater 10 and/or the electrical load circuits 11 inside and outside the heater 10 is 150 mA or less to thereby determine whether the heater 10 and/or the electrical load circuits 11 inside and outside the heater 10 are minimally stably driven.

Moreover, the control module 25 may output the low-current error code of the heater 10 through the display module 23, and for example, the display module 23 may output visual error codes such as “Erro” and “-LC-”.

The control module 25 may determine whether the current detected through the third monitoring unit is equal to or more than a predetermined second current value. When the detected current is equal to or more than the predetermined second current value, the control module 25 may display an overcurrent error code through the display module 23, and maintain the output voltage supply.

A second current value which becomes a reference for the control module 25 to display the overcurrent error code may have 22.5 A to 27.5 A, i.e., an overcurrent range of 5 A. More specifically, the control module 25 may monitor whether the current flowing on the heater 10 is equal to or more than 25 A to thereby determine whether the heater 10 and the electrical load circuits 11 inside and outside the heater 10 are maximally stably driven.

Moreover, the control module 25 may output the overcurrent error code with the heater 10 through the display module 23, and for example, the display module 23 may output visual error codes such as “Erro” and “-OC-”.

The control module 25 may transfer an output voltage interruption signal to the driving module 24 when the temperature measured through the second monitoring unit is equal to or more than a predetermined second reference temperature. That is, the control module 25 may measure a temperature of a region where the switch is placed so that the switch is not damaged by heat.

The second reference temperature for transferring the output voltage interruption signal may be 82.5° C. or more or 87.5° C. or less, and more specifically, the second reference temperature may be 85° C. Moreover, it may also be determined whether the heater 10 and/or the electrical load circuit 11 operates through the temperature value measured through the second monitoring unit. For example, the control module 25 may switch the heater 10 and/or the electrical load circuit 11 from the off state to the on state, or adjust the amount of output voltage supplied to the heater 10 and/or the electrical load circuit 11, when the temperature measured through the second monitoring unit is 50° C. or less.

Moreover, the control module 25 may output an abnormal temperature notification of the switch region through the display module 23. For example, the display module 23 may output a visual abnormal temperature notification such as “Erro” or “-Ot-”.

The power supply module 26 may receive the AC power. The power supply module 26 may include a control power supply unit (switching power) to thereby convert and output the AC power into DC power required for relay driving of the switch and communication with an external device.

The communication module 27 may connect the controller 20 to communicate with another device, e.g., the communication device 200 described above. Specifically, the communication module 27 may transmit and receive data related to the heater 10 and the electrical load circuits 11 inside and outside the heater 10 through wired/wireless communication. Here, the wireless communication may use at least one of a plurality of communication standards, protocols, and technologies, e.g., GSM, EDGE, CDMA, TDMA, Bluetooth, Wi-Fi, VoIP, Wi-MAX, or any other appropriate communication protocol, and the wired communication may use at least one of one or more wired interfaces, e.g., Ethernet, USB, FireWire, RS-232, RS-485, HDMI, POTS, or the like.

For example, the communication module 27 may transmit, to the gateway device 500 and/or the monitoring server 300, various types of errors detected by the device jointly with the identification number described above, and receive control data such as control time, temperatures, etc., of the heater 10 and the electrical load circuits 11 inside and outside the heater 10 from the monitoring server 300.

The output control module 28 may control to output different contacts according to an error or operation state generated from the controller 20. For example, the control unit 180 may maintain an output terminal in a closed state as it is when power supply is normal and open the output terminal when the power supply is abnormal.

Further, the output control module 28 may close the output terminal when an error according to an abnormal temperature and an abnormal current value occurs in the controller 20, and maintain the output terminal in an opened state as it is when the power supply is abnormal.

Further, the output control module 28 may close the output terminal when the heater 10 operates according to the operations of the heater 10 and/or the electrical load circuits 11 inside and outside the heater 10 in the controller 20, and maintain the output terminal in the opened state as it is when the heater 10 does not operate.

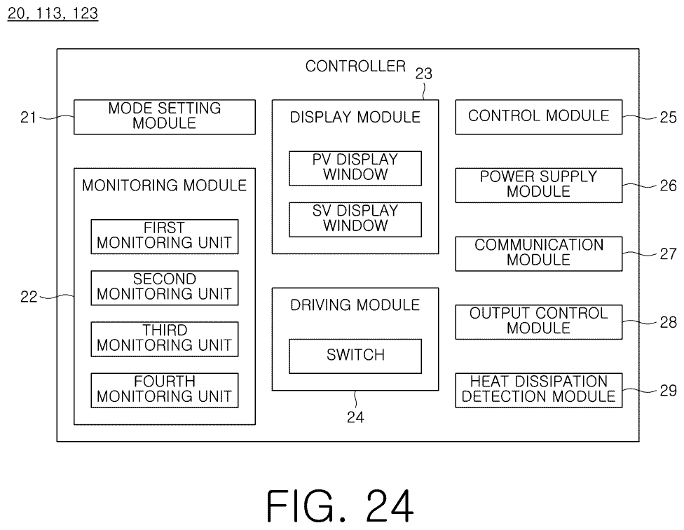

FIG. 24 is a block diagram illustrating a configuration of the controller according to an exemplary embodiment.

Referring to FIG. 24, the controller 20 further includes a heat dissipation detection module 29 sensing heat dissipation of a cable (not illustrated).

As described above, the heat dissipation detection module 29 may detect overheat of the heater 10 and the electrical load circuits 11 inside and outside the heater 10, and also detect the heat dissipation of the cable.

The cable connects the controller 20 and the electrical load circuit 11, and connects the electrical load circuit 11 and the heater 10. The heat dissipation detection module 29 may be installed on the cable in the controller 20. The heat dissipation detection module 29 may detect a cable temperature of a point from which electricity is branched in the controller 20. The control module 25 may restrict or interrupt supply current supplied by the power supply module 26 according to the temperature of the cable detected by the heat dissipation detection module 29.

As illustrated in <Table 1> below, an allowable current of the cable rapidly decreases as the temperature of the cable or the controller 20 increases. For example, a cable having a cross-sectional area of 2.5 mm² has the allowable current of 24 A at a temperature of 30° C. However, the cable has the allowable current of 17 A at a temperature of 50° C. and the allowable current of 12 A at a temperature of 60° C.

TABLE 1

| Cross-sectional | | | | | | | | | | | |
|---|---|---|---|---|---|---|---|---|---|---|---|
| area of | Maximum allowable current to which temperature correction coefficient is applied (Å) | | | | | | | | | | |
| conductor ( [symbol] ) | 10° C. | 15° C. | 20° C. | 25° C. | 30° C. | 35° C. | 40° C. | 45° C. | 50° C. | 55° C. | 60° C. |
| 1.5 | 2 [symbol] | 20. [symbol] | [symbol] | 18.6 | 17.5 | 16. [symbol] | [symbol] .2 | [symbol] .8 | [symbol] | [symbol] | 8.8 |
| 2. [symbol] | 29.3 | 28.2 | 26. [symbol] | [symbol] | 24.0 | 22.6 | 2 [symbol] .9 | [symbol] .0 | 2 [symbol] .0 | 14. [symbol] | 12.0 |
| 4 | 39.0 | [symbol] | [symbol] | [symbol] | 32.0 | 30. [symbol] | [symbol] .8 | 2 [symbol] .3 | 22.7 | 1 [symbol] | 16.0 |
| 6 | 50.0 | 48.0 | 45. [symbol] | [symbol] .5 | 41.0 | 38. [symbol] | 35.7 | 3 [symbol] .4 | 29. [symbol] | 25.0 | 2 [symbol] |
| 10 | [symbol] 9. [symbol] | 66.7 | [symbol] 3.8 | 80.4 | 57.0 | 53.6 | 49.0 | 4 [symbol] .0 | 40.5 | 34.8 | 28. [symbol] |
| 16 | 92. [symbol] | [symbol] | 85.1 | 80. [symbol] | 76.0 | 7 [symbol] | [symbol] .1 | [symbol] .0 | 54.0 | 46.4 | 38.0 |
| 25 | [symbol] | 128.2 | [symbol] 13.1 | 107.1 | 101.0 | 94. [symbol] | 87.9 | 79.8 | 71.7 | 62.6 | 50.5 |
| 35 | [symbol] | 146.3 | 24 [symbol] .0 | 132.9 | 125.0 | 137.5 | 108.8 | 98.8 | 88.8 | 7 [symbol] .3 | 62.5 |
| 50 | 18 [symbol] | 17 [symbol] .7 | [symbol] .1 | 169.2 | 151.0 | 141.9 | 132.4 | 129.3 | 107. [symbol] | 92. [symbol] | [symbol] |
| 70 | 234.2 | 22 [symbol] | 215.0 | 203. [symbol] | 192.0 | 180.5 | 16 [symbol] .0 | [symbol] 52.7 | 136.3 | 1 [symbol] | 96.0 |
| 95 | 2 [symbol] | [symbol] | 2 [symbol] 9. [symbol] | 24 [symbol] | 232.0 | 228. [symbol] | 202. [symbol] | [symbol] .3 | 164.7 | 1 [symbol] .5 | 128.0 |
| 120 | 32 [symbol] .2 | [symbol] | 30 [symbol] .3 | 28 [symbol] | 269.0 | 252.3 | 2 [symbol] .0 | 2 [symbol] | 19 [symbol] .0 | 1 [symbol] | 134.5 |
| 150 [symbol] | [symbol] | 402.5 | 38 [symbol] .3 | 3 [symbol] .6 | 344.0 | 323.4 | 2 [symbol] .3 | 2 [symbol] .8 | 2 [symbol] .2 | 209.8 | 172.0 |
| 185 [symbol] | [symbol] .2 | 458.6 | [symbol] .0 | 4 [symbol] | 392.0 | 388. [symbol] | 34 [symbol] .0 | 30 [symbol] .7 | 2 [symbol] | 239. [symbol] | 196.0 |
| 240 [symbol] | [symbol] 2.4 | [symbol] | [symbol] .3 | 48 [symbol] .7 | 461.0 | 4 [symbol] .3 | 40 [symbol] .1 | 3 [symbol] .2 | 327.3 | 28 [symbol] .2 | 230. [symbol] |
| 300 [symbol] | [symbol] 6.6 | 620.3 | [symbol] 93.6 | 561.8 | 530.0 | 4 [symbol] 8.2 | 4 [symbol] | 418.7 | 376. [symbol] | 323.3 | 285.0 |

[symbol]

indicates data missing or illegible when filed

The heat dissipation detection module 29 senses the temperature of the cable, and the control module 25 restricts the current supplied by the power supply module 26 within the allowable current according to the temperature of the cable or interrupts the current to prevent a fire in the controller 20. The temperature of the cable sensed by the heat dissipation detection module 29, and supply current restriction and/or interruption information of the control module 25 and the power supply module 26 may be transmitted to the monitoring server 300 through the communication device 200, and the user terminal 400 may confirm the temperature of the cable, and the supply current restriction and/or interruption information by accessing the monitoring server 300.

FIG. 25 is a block diagram schematically illustrating a configuration of an electrical fire prevention and prediction system for electrical load circuits based on IoT according to another exemplary embodiment of the present disclosure, and FIG. 26 is a block diagram schematically illustrating a configuration of an electrical fire prevention and prediction system for electrical load circuits based on IoT according to yet another exemplary embodiment of the present disclosure.

Specifically, FIG. 25 is a block diagram schematically illustrating a configuration of an electrical fire prevention and prediction system 1000 for electrical load circuits based on IoT when the electrical device is the cooler 110 according to the present disclosure, and FIG. 26 is a block diagram schematically illustrating a configuration of an electrical fire prevention and prediction system 1000 for electrical load circuits based on IoT when the electrical device is the electrical switchboard 120 according to the present disclosure.

As described above, the electrical device according to the present disclosure includes a freeze prevention device 100, a cooler 110, and an electrical switchboard 120. The electrical load circuits 11, 112, and 122 according to the present disclosure may include electrical load circuits 112 and 122 installed in the freeze prevention device 100, the cooler 110, and the electrical switchboard 120.

The respective components of the electrical fire prevention and prediction system 1000 for electrical load circuits based on IoT described with reference to FIGS. 1 to 24 may also be similarly applied to a case where the electrical devices described with reference to FIGS. 25 and 26 are the cooler 110 or the electrical switchboard 120.

Referring to FIG. 25, the electrical fire prevention and prediction system 1000 for electrical load circuits based on IoT according to the present disclosure includes a cooler 110, a communication device 200, a monitoring server 300, and a user terminal 400.

The cooler 110 means an electrical device that cools an object. For example, the cooler 110 includes a cooling device 111 that prevents overheat of a heat exchange or an engine, and includes cooling devices 111 including a heat pipe or a vapor chamber.

The cooler 110 includes the cooling device 111 for cooling the object. The cooler 110 includes a controller 113 controlling driving of the cooling device 111. The cooler 110 includes an electrical load circuit 112 that connects an electrical power source, wires, and switches so that current may flow between the cooling device 111 and the controller 113. The electrical load circuit 112 for driving the cooling device 111 is also included in the cooling device 111. The cooler 110 includes the electrical load circuits 112 inside and outside the cooling device 111.

The controller 113 controls the driving of the cooling device 111 and the electrical load circuits 112 inside and outside the cooling device 111. The controller 113 detects the driving of the cooling device 111 and the electrical load circuits 112 inside and outside the cooling device 111 to generate driving information of the cooling device 111 and the electrical load circuits 112 inside and outside the cooling device 111. In this case, the driving information includes electrical power source information of the electrical load circuit 112.

The controller 113 generates error information such as disconnection, overcurrent, spark, current leakage, and overheat generation of the cooling device 111 and the electrical load circuits 112 inside and outside the cooling device 111 based on the generated driving information. As an exemplary embodiment, the controller 113 may be connected to a plurality of cooling devices 111 and the electrical load circuits 112 in series or in parallel. As an exemplary embodiment, the controller 113 may receive error signals such as disconnection, overcurrent, spark, current leakage, and overheat of the cooling device 111 and the electrical load circuits 112 inside and outside the cooling device 111 from any one cooling device 111 and electrical load circuit 112 among the plurality of cooling devices 111 and electrical load circuits 112. As an exemplary embodiment, the controller 113 may generate error information such as disconnection, overcurrent, spark, current leakage, and overheat of the cooling device 111 and the electrical load circuits 112 based on the driving information detected from the plurality of cooling devices 111 and electrical load circuits 112, respectively.

The controller 113 generates fire occurrence possibility information based on at least any one of disconnection, overcurrent, spark, current leakage, and overheat generation of the cooling device 111 and the electrical load circuits 112.

The monitoring server 300 may receive the fire occurrence possibility information through the communication device 200, and provide the received fire occurrence possibility information to the user terminal 400.

Referring to FIG. 26, the electrical fire prevention and prediction system 1000 for electrical load circuits based on IoT according to the present disclosure includes the electrical switchboard 120, the communication device 200, the monitoring server 300, and the user terminal 400.

The electrical switchboard 120 supplies power to an electronic device. As an exemplary embodiment, the electrical switchboard 120 distributes and supplies the power to the freeze prevention device 100, the cooler 110, the communication device 200, the monitoring server 300, and the like. The electrical switchboard 120 includes an electrical supply device 121 for distribution and supplying the power. The electrical switchboard 120 includes a controller 123 controlling driving of the electrical supply device 121. The electrical switchboard 120 includes an electrical load circuit 122 that connects an electrical power source, wires, and switches so that current may flow between the electrical supply device 121 and the controller 123. The electrical load circuit 122 for driving the electrical supply device 121 is also included in the electrical supply device 121. The electrical switchboard 120 includes the electrical load circuits 122 inside and outside the electrical supply device 121.

The controller 123 controls the driving of the electrical supply device 121 and the electrical load circuits 122 inside and outside the electrical supply device 121. The controller 123 detects the driving of the electrical supply device 121 and the electrical load circuits 122 inside and outside the electrical supply device 121 to generate driving information of the electrical supply device 121 and the electrical load circuits 122 inside and outside the electrical supply device 121. In this case, the driving information includes electrical power source information of the electrical load circuit 122.

The controller 123 generates error information of the electrical supply device 121 and the electrical load circuits 122 inside and outside the electrical supply device 121 based on the generated driving information. As an exemplary embodiment, the controller 123 may be connected to a plurality of electrical supply devices 121 and electrical load circuits 122 inside and outside the electrical supply device 121 in series or in parallel. As an exemplary embodiment, the controller 123 may receive error signals such as disconnection, overcurrent, spark, current leakage, and overheat of the electrical supply device 121 and the electrical load circuits 122 inside and outside the electrical supply device 121 from any one electrical supply device 121 and/or the electrical load circuits 122 inside and outside the electrical supply device 121 among the plurality of electrical supply devices 121 and the electrical load circuits 122 inside and outside the electrical supply device 121. As an exemplary embodiment, the controller 123 may generate error information such as disconnection, overcurrent, spark, current leakage, and overheat generation between the electrical supply device 121 and the electrical load circuits 122 inside and outside the electrical supply device 121 based on the driving information detected from the plurality of electrical supply devices 121 and the electrical load circuits 122 inside and outside the electrical supply device 121, respectively.

The controller 123 generates fire occurrence possibility information based on at least any one of disconnection, overcurrent, spark, current leakage, and overheat generation information of the electrical supply device 121 and the electrical load circuits 122.

The monitoring server 300 may receive the fire occurrence possibility information through the communication device 200, and provide the received fire occurrence possibility information to the user terminal 400.

Referring to FIGS. 1, 25, and 26, the electrical fire prevention and prediction system 1000 for electrical load circuits based on IoT according to the present disclosure includes the freeze prevention device 100, the cooler 110, the electrical switchboard 120, the communication device 200, the monitoring server 300, and the user terminal 400. The freeze prevention device 100, the cooler 110, and the electrical switchboard 120 include controllers 20, 113, and 123 that control driving of electrical load circuits 11, 112, and 122 in respective components 10, 111, and 121, and generate driving information, error information, and fire occurrence possibility information of the electrical load circuits 11, 112, and 122, respectively. The respective controllers 20, 113, and 123 transmit, to the monitoring server 300, the generated driving information, error information, and fire occurrence possibility information of the electrical load circuits 11, 112, and 122 through the communication device 200, and the monitoring server 300 transmits, to the user terminal 400, the received driving information, error information, and fire occurrence possibility information of the electrical load circuits 11, 112, and 122 to prevent and predict electrical fires of the electrical load circuits 11, 112, and 122.

A plurality of freeze prevention devices 100, coolers 110, and electrical switchboards 120 may be grouped and managed as described above.

The communication device 200 and the user terminal 400 according to the present disclosure may access the monitoring server 300 through the communication network, and include all components capable of processing digital information capable of installing an application program which may input search information and selection information, and display searched result information. The user terminal 400 according to the present disclosure as a component that accesses the monitoring server 300 through the communication network to transmit/receive information may include, for example, at least one of a smartphone, a tablet personal computer (PC), a mobile phone, a video phone, a desktop PC, a laptop PC, a netbook computer, a personal digital assistant (PDA), a portable multimedia player (PMP), a wearable device (e.g., smart glasses, head-mounted device (HMD), etc.), a kiosk, or a smart watch.

The communication module, the communication device 200, the user terminal 400, and the monitoring server 300 according to the present disclosure may communicate with each other through communication units and communication networks provided therein, respectively. The communication network refers to a connection structure in which information may be exchanged between respective nodes such as terminals and servers, and an example of such a communication network includes a 3rd generation partnership project (3GPP) network, a long term evolution (LTE) network, a world interoperability for microwave access (WIMAX) network, Internet, a local area network (LAN), wireless local area network (LAN), a wide area network (WAN), a personal area network (PAN), a Wi-Fi network, a Bluetooth network, a satellite broadcasting network, an analog broadcasting network, a digital multimedia broadcasting (DMB) network, etc., but is not limited thereto. The communication units provided in the user terminal 400 and the monitoring server 300, respectively may include an electronic component provided for the communication network so as to perform wired/wireless data communication through the above-described communication network.

The database server 320 according to the present disclosure may include a database management system (hereinafter, referred to as DBMS). The DBMS is a set of software tools which allow multiple users to access data in the database server 320. The DBMS may include IMS, CODASYL DB, DB2, ORACLE, INFORMIX, SYBASE, INGRES, MS-SQL, Objectivity, O2, Versanat, Ontos, Gemstone, Unisql, Object Store, Starburst, Postgres, Tibero, MySQL, MS-access, or the like. The DBMS is capable of accessing corresponding specific data according to input of a specific instruction.

In the present specification, the mode setting module 21, the monitoring module 22, the display module 23, the driving module 24, the control module 25, the power supply module 26, the communication module 27, and the output control module 28 may be processors that execute continuous performing processes stored in the memory. Alternatively, the modules may operate as software modules driven and controlled by the processor. Furthermore, the processor may be a hardware device.

In the present specification, ‘part’ includes a unit implemented by hardware, a unit implemented by software, and a unit implemented by using both the hardware and the software. Further, one unit may be implemented by using two or more hardware, and two or more units may be implemented by one hardware.

A protection scope of the present disclosure is not limited to disclosure and expression of the exemplary embodiment explicitly described above. Further, it is additionally mentioned once again that the protection scope of the present disclosure cannot be limited due to apparent change or substitution in a technical field to which the present disclosure belongs.

What is claimed is:

1. An electrical fire prevention and prediction system for electrical load circuits based on IoT, comprising:
an electrical load circuit;
a controller controlling driving of the electrical load circuit, generating driving information of the electrical load circuit, and generating error information of the electrical load circuit based on the driving information;
a communication device receiving the driving information and the error information from the controller;
a monitoring server receiving the driving information and the error information from the communication device; and
a user terminal accessing the monitoring server and receiving the driving information and the error information.

2. The electrical fire prevention and prediction system for electrical load circuits based on IoT of claim 1, wherein the driving information includes electrical power source information of the electrical load circuit, and
the error information includes at least any one of disconnection, overcurrent, spark, current leakage, and overheat generation information of the electrical load circuit.

3. The electrical fire prevention and prediction system for electrical load circuits based on IoT of claim 2, wherein the controller generates fire occurrence possibility information based on at least any one of the disconnection, the overcurrent, the spark, the current leakage, and the overheat generation information of the electrical load circuit, and
the monitoring server receives the fire occurrence possibility information through the communication device, and provides the fire occurrence possibility information to the user terminal.

4. The electrical fire prevention and prediction system for electrical load circuits based on IoT of claim 3, wherein the monitoring server includes a web server providing a monitoring platform to the user terminal.

5. The electrical fire prevention and prediction system for electrical load circuits based on IoT of claim 4, wherein the monitoring server receives the fire occurrence possibility information through the communication device, and then
discloses a fire warning message and fire warning details information to the platform, and
transmits, to the user terminal, a text message including the fire warning details information.

6. The electrical fire prevention and prediction system for electrical load circuits based on IoT of claim 1, wherein the electrical load circuit is included in each of a freeze prevention device, a cooler, and an electrical switchboard.

7. The electrical fire prevention and prediction system for electrical load circuits based on IoT of claim 1, wherein the controller further includes a heat dissipation detection module sensing heat dissipation of a cable.

8. The electrical fire prevention and prediction system for electrical load circuits based on IoT of claim 7, wherein the controller further includes a control module that restricts or interrupts supply current supplied to the cable according to a temperature of the cable sensed by the heat dissipation detection module.

9. An electrical fire prevention and prediction system for electrical load circuits based on IoT, comprising:
a plurality of electrical devices;
a plurality of controllers controlling driving of an electrical load circuit in the electrical device, generating driving information of the electrical load circuit, and generating error information of the electrical load circuit based on the driving information;
a communication device receiving the driving information and the error information from the plurality of controllers;
a monitoring server receiving the driving information and the error information from the communication device; and
a user terminal accessing the monitoring server and receiving the driving information and the error information,
wherein the monitoring server provides, to the user terminal, a plurality of driving information and error information received from the plurality of controllers, respectively.

10. The electrical fire prevention and prediction system for electrical load circuits based on IoT of claim 9, wherein the plurality of controllers includes identification numbers, respectively, and
the monitoring server provides, to the user terminal, the plurality of driving information and error information jointly with the identification numbers.

11. The electrical fire prevention and prediction system for electrical load circuits based on IoT of claim 10, further comprising:
a plurality of communication devices,
wherein the plurality of communication devices is connected to a plurality of controllers, respectively and grouped, and
the monitoring server provides, to the user terminal, the plurality of driving information and error information jointly with group information in which a plurality of controllers connected to one communication device is grouped.

12. The electrical fire prevention and prediction system for electrical load circuits based on IoT of claim 11, wherein the monitoring system further includes a gateway device connecting the plurality of communication devices and the monitoring server, and
the plurality of communication devices and the gateway device wirelessly communicate through a LoRa network.

13. The electrical fire prevention and prediction system for electrical load circuits based on IoT of claim 11, wherein the communication device and the monitoring server are connected through a wired communication network.

14. The electrical fire prevention and prediction system for electrical load circuits based on IoT of claim 9, wherein the electrical device is a freeze prevention device, a cooler, or an electrical switchboard.
